(19) United States
(12) Patent Application Publication
(10) Pub. No.: US 2017/0339605 A1
(43) Pub. Date: Nov. 23, 2017

(54) METHOD OF HANDOVER, METHOD OF MANAGING A MOBILE DEVICE AND THE MOBILITY MANAGEMENT ENTITY THEREOF, AND MOBILE BASE STATION AND ITS MANAGEMENT METHOD THEREOF

(71) Applicant: INDUSTRIAL TECHNOLOGY RESEARCH INSTITUTE, Hsinchu (TW)

(72) Inventors: Kuang-Hao LIU, New Taipei City (TW); Phone LIN, Taipei City (TW); Chih-Wei HUANG, Taipei City (TW); Chia-Peng LEE, Yilan County (TW); Chia-Lin LAI, Tainan City (TW)

(73) Assignee: INDUSTRIAL TECHNOLOGY RESEARCH INSTITUTE, Hsinchu (TW)

(21) Appl. No.: 15/263,129

(22) Filed: Sep. 12, 2016

(30) Foreign Application Priority Data
May 18, 2016 (TW) 105115399

(51) Int. Cl. H04W 36/00

(52) U.S. Cl. CPC H04W 36/0061; H04W 36/0077

(57) ABSTRACT

A method of handover is provided. It includes: performing a mobile base station tracking area update procedure; performing a mobile device tracking area update procedure; transmitting a mobile base station identity of the mobile base station to a mobile device mobility management entity corresponding to the mobile device by a fixed base station; transmitting a request for setting the mobile base station ID to the mobile device by the MD mobility management entity; writing the mobile device ID into a mobile network ID list of the mobile device by the mobile device; when the mobile device receives from the fixed base station a handover message indicating the mobile device to hand over to the mobile base station and the mobile device determines the mobile network ID list includes the mobile base station ID of the mobile base station, then, the mobile device hands over to the mobile base station.

### CROSS-REFERENCE TO RELATED APPLICATIONS

This non-provisional application claims priority under 35 U.S.C. §119(a) on Patent Application No. 105,115,399 filed in Taiwan on May 18, 2016, the entirety of which is incorporated herein by reference.

### TECHNICAL FIELD

This disclosure relates to a method of handover, a method of managing a mobile device and the mobility management entity thereof, and a mobile base station and its management method thereof.

### BACKGROUND OF THE DISCLOSURE

In recent years, many countries have established their high-speed train systems. High-speed train provides people with travels between cities or countries. If the high-speed train system can provide network services to train passengers to smoothly browse the web, watch online videos, as well as deal with instant messaging or electronic mail (EMAIL), it will provide a user-friendly environment.

In the Long Term Evolution-Advanced (LTE-A) working group, using the mobile relay (MR) technology to provide high speed train systems is discussed. The mobile relay could be located in each train carriage or in part of the train carriages. Mobile devices could be connected to the nearest mobile relay. For mobile devices, the mobile relay plays the role of a base station. The mobile relay redirects the data sent by the mobile device to the donor eNBs (DeNBs) which are along the train route. On the other hand, the mobile relay will redistribute the data from the network side to the mobile devices.

However, if the high-speed train system allows a mobile device smoothly handover to the mobile relay within a train when the mobile device enters the train and moves with the train, it will provide a smoother wireless communication environment. Regardless the development of the Long Term Evolution-Advanced (LTE-A) technology nowadays, it can be expected for certain, the development of mobile Internet is a trend. Therefore, the mobile base station (such as LTE-A mobile relay) appears more important. How to design an efficient and reliable handover scheme for allowing users to have smooth network services in carriages (such as high-speed train) becomes an important issue.

### SUMMARY

This disclosure relates to a method of handover, a method of managing a mobile device and the mobility management entity thereof, and a mobile base station and its management method thereof.

According to one of the embodiments of the present disclosure, there is provided a method of handover, adapted to a moving network system. The method comprises: performing a mobile base station (MBS) tracking area update procedure corresponding to a mobile base station; performing a mobile device (MD) tracking area update procedure corresponding to a mobile device; transmitting, by a fixed base station, a mobile base station identity (ID) of the mobile base station to a mobile device (MD) mobility management entity corresponding to the mobile device; transmitting, by the MD mobility management entity, a request for setting the mobile base station ID to the mobile device; writing, by the mobile device, the mobile base station ID into a mobile network ID list of the mobile device; and when the mobile device receives from the fixed base station a handover message indicating the mobile device to hand over to the mobile base station and the mobile device determines the mobile network ID list includes the mobile base station ID of the mobile base station, then, the mobile device hands over to the mobile base station.

According to one of the embodiments of the present disclosure, there is provided a method of managing a mobile device, adapted to a mobile device (MD) mobility management entity, the method comprises: performing a mobile device (MD) tracking area update procedure corresponding to a mobile device; receiving a mobile base station identity (ID) of a mobile base station from a fixed base station; and transmitting a request for setting the mobile base station ID to the mobile device, so that the mobile device writes the mobile station ID into a mobile network ID list of the mobile device.

According to one of the embodiments of the present disclosure, there is provided a mobile device (MD) mobility management entity. The mobile device (MD) mobility management entity comprises a communication unit and an execution unit. The communication unit is configured to transmit and receive messages. The execution unit is configured to perform: a mobile device (MD) tracking area update procedure corresponding to a mobile device; receiving a mobile base station identity (ID) of a mobile base station from a fixed base station; and transmitting a request for setting the mobile base station ID to the mobile device, so that the mobile device writes the mobile station ID into a mobile network ID list of the mobile device.

According to one of the embodiments of the present disclosure, there is provided a management method of a mobile base station, adapted to the mobile base station. The method comprises: writing at least two network identities (IDs) into a first broadcasting system message; and periodically broadcasting the first broadcasting system message, for providing a first mobile device to determine if there is any one of the at least two network IDs presents in a first mobile network ID list of the first mobile device, wherein when there is any one of the at least two network IDs presents in the first mobile network ID list of the first mobile device and the first mobile device receives a first handover message indicating the first mobile device to hand over to the mobile base station, then, the first mobile device hands over to the mobile base station.

According to one of the embodiments of the present disclosure, there is provided a mobile base station. The mobile base station comprises a communication unit and an execution unit. The communication unit is configured to transmit and receive messages. The execution unit is configured to: write at least two network identities (IDs) into a first broadcasting system message; and periodically broadcast the first broadcasting system message, for providing a first mobile device to determine if there is any one of the at least two network IDs presents in a first mobile network ID list of the first mobile device, wherein when there is any one of the at least two network IDs presents in the first mobile network ID list of the first mobile device and the first mobile device receives a first handover message indicating the first mobile device to hand over to the mobile base station, the first mobile device hands over to the mobile base station.

Further scope of applicability of the present disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1(a) and FIG. 1(b) show scenarios of the disclosed embodiments.

FIG. 2 shows a system architecture, according to exemplary embodiments.

FIG. 3 shows a handover method, according to an exemplary embodiment.

FIG. 4(a) and FIG. 4(b) show scenarios of handover methods in the Long Term Evolution-Advanced (LTE-A) system, according to exemplary embodiments.

FIG. 5 shows a method of managing a mobile device, according to an exemplary embodiment.

FIG. 6 shows a block diagram of a MD mobility management entity, according to an exemplary embodiment.

FIG. 7 shows a management method of a mobile base station, according to an exemplary embodiment.

FIGS. 8(a)˜8(d) show the broadcasting system messages, according to exemplary embodiments.

FIG. 9 shows a block diagram of a mobile base station, according to an exemplary embodiment.

### DESCRIPTION OF THE EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

This disclosure is applicable to moving networks, such as high-speed moving networks, but not limited thereto.

For descriptive convenience, the Long Term Evolution-Advanced (LTE-A) system is hereinafter referred to as LTE-A system.

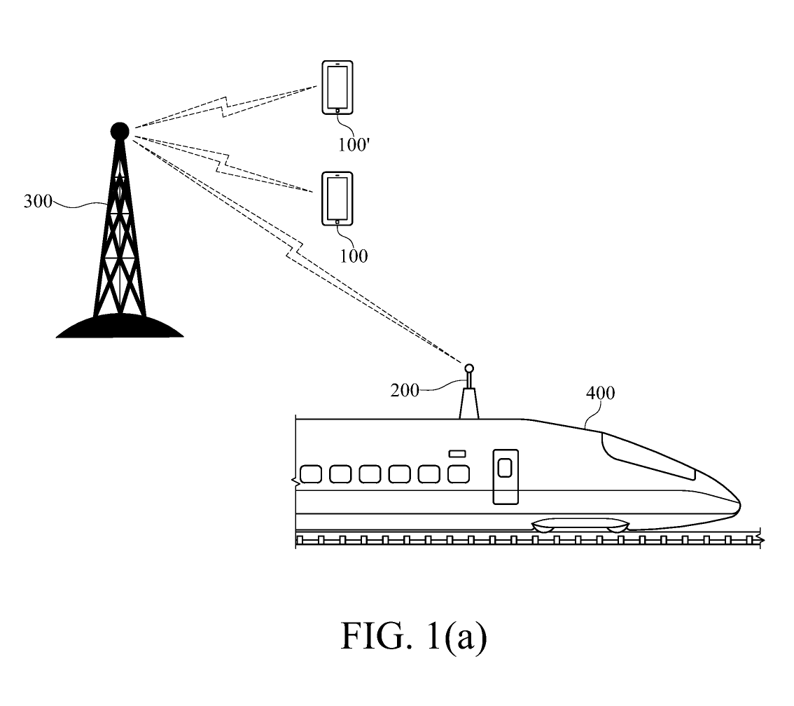

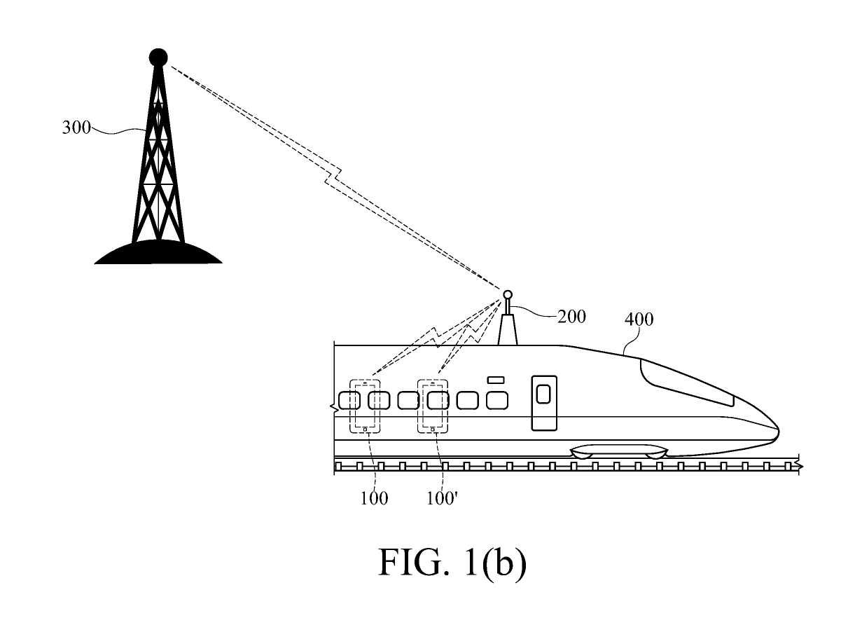

FIG. 1(a) and FIG. 1(b) show scenarios of the disclosed embodiments. As shown in FIG. 1(a), it includes at least one a mobile device (for example, mobile devices 100,100′), a mobile base station 200 and a fixed base station 300. Using the mobile device 100 as an example for illustration, when the mobile device 100 moves into the coverage area of the fixed base station 300, an MD tracking area update (TAU) procedure corresponding to the mobile device 100 will be performed. So that the back-end system can trace the physical location of the mobile device 100. Similarly, when the mobile base station 200 moves into the coverage area of the fixed base station 300, an MBS tracking area update (TAU) procedure corresponding to the mobile base station 200 will be performed. So that the back-end system can trace the location of the mobile base station 200.

As shown in FIG. 1(b), when the mobile device 100 moves into a carriage 400, the mobile device 100 will be in the coverage area of the mobile base station 200. When the carriage 400 moves, it can be expected, the mobile device 100 will successively hand over to other fixed base stations which are along the route. If the mobile device 100 hands over to the mobile base station 200, then, the mobile device 100 may have the network service with other fixed base station(s) through the mobile base station 200. The carriage 400 in FIG. 1(b) may be, but not limited to a carriage of a high-speed train. The applicable scenario may include other carriage, for example, a car, a helicopter, a bus, a subway or other transport vehicles which provide group moving, etc.

As shown in FIG. 1(a), a fixed base station 300 is a serving base station corresponding to the mobile device 100 (100′) and the mobile base station 200. As shown in FIG. 1(b), the fixed base station 300 is the serving base station corresponding to the mobile base station 200. And, after the mobile device 100 hands over to the mobile base station 200, the mobile base station 200 is the serving base station corresponding to the mobile device 100.

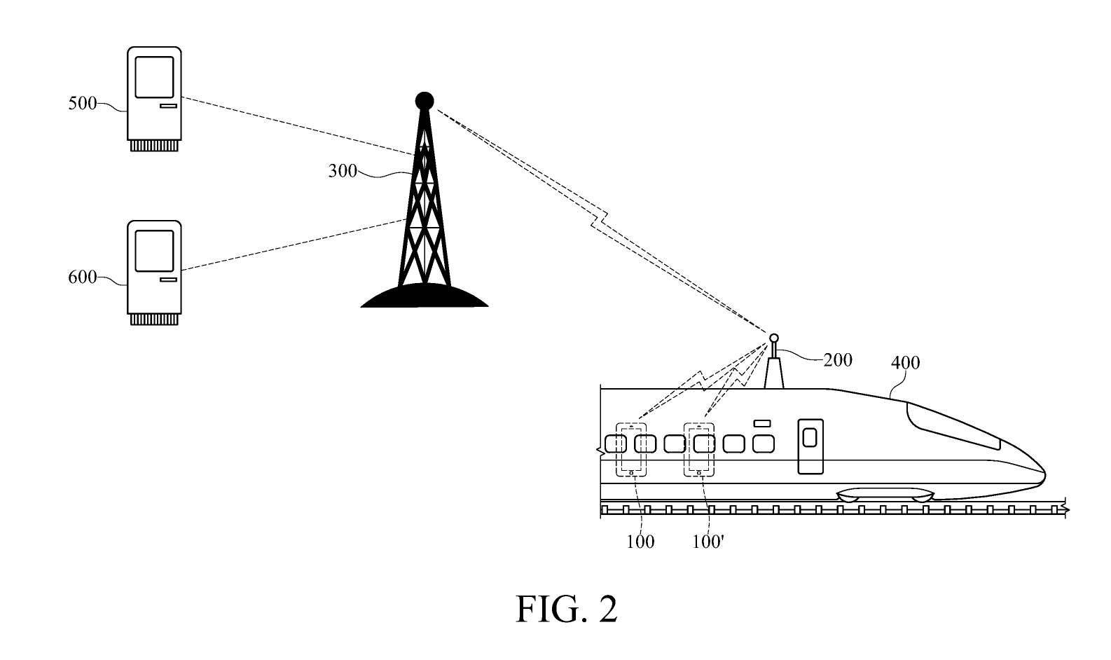

FIG. 2 shows the system architecture according to exemplary embodiments of the present disclosure. In addition to FIG. 1(a) and FIG. 1(b), FIG. 2 further includes a mobile device (MD) mobility management entity (MME_{MD}) 500 and a mobile base station (MBS) mobility management entity (MME_{MBS}) 600 of the back-end system. In embodiments, the MD mobility management entity (MME_{MD}) 500 and the MBS mobility management entity (MME_{MBS}) 600 are responsible for the mobility management of a wireless network system. In embodiments, the MD mobility management entity (MME_{MD}) 500 and the MBS mobility management entity (MME_{MBS}) 600 are responsible for the mobility management of the mobile device (for example, mobile base station 200, mobile device 100), the management of bearer, and the management of security, etc.

This application provides a method and an apparatus for a mobile device to hand over to a mobile base station. For the convenience of explanation, the LTE-A system is used as an example, but not limited thereto.

In FIG. 2, the mobile base station 200 for example is a mobile relay (MR), the fixed base station 300 for example is a Doner eNB (DeNB), the MD mobility management entity (MME_{MD}) 500 and the MBS mobility management entity (MME_{MBS}) 600 for example are Mobility Management Entities (MMEs) respectively corresponding to the mobile device 100 and the mobile base station 200. The carriage 400 for example is a carriage of a high-speed train, but not limited thereto.

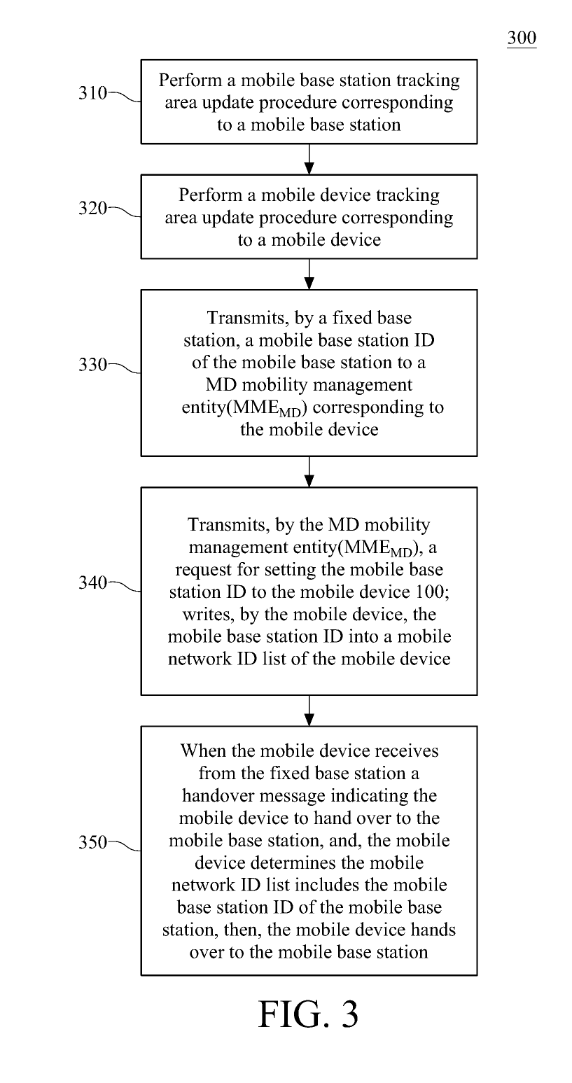

FIG. 3 is a flowchart of a handover method according to an exemplary embodiment of the present disclosure. The method is applicable to a moving network system. The method is further described below. The moving network system is configured to: perform a MBS tracking area update procedure corresponding to a mobile base station (step 310); perform a MD tracking area update procedure corresponding to a mobile device (step 320); transmits, by a fixed base station 300, a mobile base station ID of the mobile base station to a MD mobility management entity (MME_{MD}) 500 corresponding to the mobile device 100 (step 330); transmits, by the MD mobility management entity (MME_{MD}) 500, a request for setting the mobile base station ID to the mobile device 100; writes, by the mobile device 100, the mobile base station ID into a mobile network ID list of the mobile device 100 (step 340); and when the mobile device 100 receives from the fixed base station 300 a handover message which indicates the mobile device 100 to hand over to the mobile base station 200 and the mobile device determines the mobile network ID list includes the mobile base station ID of the mobile base station, the mobile device 100 hands over to the mobile base station 200 (step 350).

Wherein, the mobile device 100, the fixed base station 300 and the MD mobility management entity (MME_{MD}) 500 which correspond to the mobile device, participate the MD tracking area update procedure. The mobile base station 200, the fixed base station 300 and a MBS mobility management entity (MME_{MBS}) 600 which correspond to the mobile base station, participate the MBS tracking area update procedure.

According to exemplary embodiments, in step 340, the MD mobility management entity (MME_{MD}) 500 transmits a request through the fixed base station 300 for setting the mobile base station ID to the mobile device 100.

The handover procedure mentioned in step 350 follows the procedure as defined in the practical application of the system, such as the handover procedure of the LTE-A system, the handover procedure of the S1/X2, the Macro Diversity Handover (MDHO), and the Fast BS Switch (FBSS), etc. It should refer to the definition of individual system, and does not require additional explanation here.

According to exemplary embodiments, in step 340, the MD mobility management entity 500 transmits a request for setting the mobile base station ID to the mobile device 100, and the mobile device 100 writes the received mobile base station ID into a mobile network ID list of the mobile device 100.

According to exemplary embodiments, the MBS tracking area update procedure (step 310) and MD tracking area update procedure (step 320) are not limited to the order of being performed, while the consideration is only based on the MBS or the MD enters the coverage area of the fixed base station. In one embodiment, the MBS tracking area update procedure and the MD tracking area update procedure are performed periodically. In another embodiment, the MBS tracking area update procedure (step 310) is initialed when the mobile base station 200 moves into the coverage area of the fixed base station 300, the MD tracking area update procedure (step 320) is initialed when the mobile device 100 moves into the coverage area of the fixed base station 300.

In embodiments, step 330 and step 340 are performed during the MBS tracking area update procedure (step 310) or the MD tracking area update procedure (step 320).

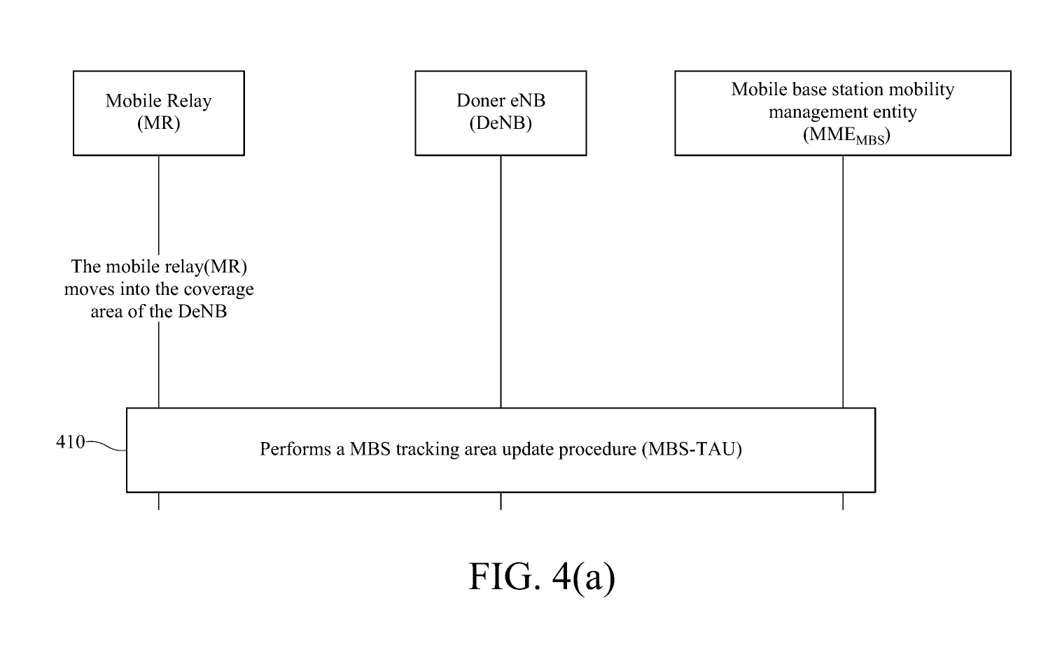

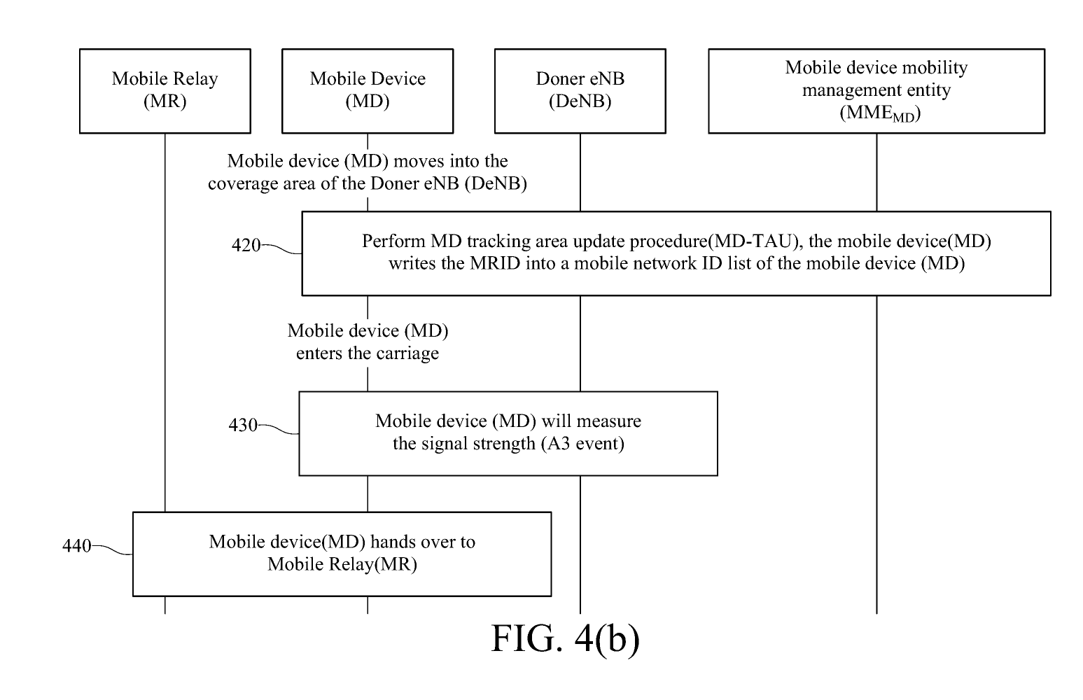

Here, FIG. 4(a) and FIG. 4(b) are used as an example for additional illustration of FIG. 3. FIG. 4(a) and FIG. 4(b) show the proposed handover method implemented in the LTE-A system. As shown in FIG. 4(a), when the mobile relay (MR) moves into the coverage area of the Doner eNB (DeNB), such as when the high-speed train moves into the station, the MR in the carriage will be in the coverage area of the DeNB, the system performs a MBS tracking area update procedure corresponding to the MR (step 410). Wherein the MR, the DeNB and a MBS mobility management entity (MME_{MBS}) which correspond to the MR, participate the MBS tracking area update procedure.

As shown in FIG. 4(b), when the mobile device moves into the coverage area of the DeNB which is at the station nearby, the system performs a MD tracking area update procedure corresponding to the mobile device (step 420). Wherein, the mobile device, the DeNB and a MD mobility management entity (MME_{MD}) which correspond to the mobile device, participate the MD tracking area update procedure. In the MD tracking area update procedure (step 420), in addition to the original tracking area update procedure defined in individual system (for example, the Tracking Area Update procedure of the LTE-A system), it further comprises: the DeNB transmits the MRID (mobile base station ID of the mobile MR) to the MME_{MD} which correspond to the mobile device; the MME_{MD} transmits a request for setting the MRID to the mobile device, and the mobile device writes the MRID into a mobile network ID list of the mobile device. The mobile network ID list described here, for example is, the Equivalent Home Public Land Mobile Network List (EHPLMN list). When the mobile device enters the carriage and moves with the high-speed train, the mobile device (MD) will measure the signal strength (for example, the A3 event of LTE-A system) (step 430). When the mobile device moves away from the DeNB, the signal strength of the MR is stronger than the signal strength of the DeNB. The DeNB will determine the mobile device hands over to the MR. When the mobile device receives from the DeNB a handover message which indicates the mobile device to hand over to the MR, and, the mobile device determines the EHPLMN list includes the MRID (mobile base station ID of the mobile relay), then, the mobile device hands over to the MR (step 440).

In embodiments, the MD tracking area update procedure (step 320) is initialed by the mobile device 100 or the MD mobility management entity (MME_{MD}) 500.

In embodiments, the MBS tracking area update procedure (step 310) is initialed by the mobile base station 200 or the MBS mobility management entity (MME_{MBS}) 600.

In embodiments, the step of transmitting the request for setting the mobile base station ID to the mobile device, further comprises: setting the mobile base station ID to be a high priority.

In embodiments, the mobile network ID list comprises the mobile base station ID and at least one other mobile base station ID.

In embodiments, the fixed base station comprises at least one combination of a donor eNB, a small cell base station, a macro eNB, and a relay node, etc.

In embodiments, the mobile device 100 periodically return the signal strength of at least one nearby base station to the fixed base station 300 according to the request by the fixed base station 300,

In embodiments, the fixed base station 300 determines the mobile device 100 hands over to the mobile base station 200 according to the signal strength of the at least one nearby base station.

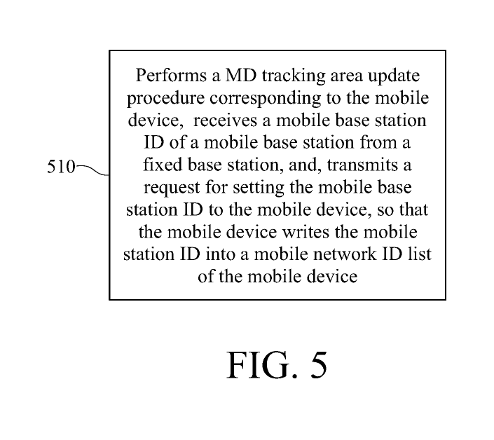

FIG. 5 is a flowchart of a method of managing a mobile device according to an exemplary embodiment of present disclosure. It is adapted to a MD mobility management entity (MME_{MD}) 500. The step 510 is described below. The MD mobility management entity (MME_{MD}) 500 performs a MD tracking area update procedure corresponding to the mobile device 100, the MD mobility management entity (MME_{MD}) 500 receives a mobile base station ID of a mobile base station 200 from a fixed base station 300, and, the MD mobility management entity (MME_{MD}) 500 transmits a request for setting the mobile base station ID to the mobile device 100, so that the mobile device 100 writes the mobile station ID into a mobile network ID list of the mobile device 100.

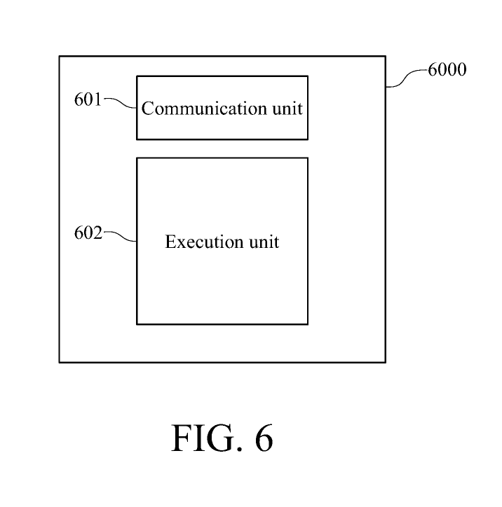

FIG. 6 shows a block diagram of a MD mobility management entity (MME_{MBS}) 6000, according to an exemplary embodiment. The MD mobility management entity (MME_{MBS}) 6000 comprises a communication unit 601 and an execution unit 602. The communication unit 601 is configured to transmit and receive messages. The execution unit 602 is configured to perform the method of managing a mobile device described above (shown in FIG. 5).

In embodiments, the communication unit 601 (shown in FIG. 6) is configured at least to receive message from the fixed base station 300 and transmit message to the fixed base station 300.

In embodiments, the execution unit 602 is realized by a processing unit for reading a plurality of computer-executable instructions from at least one storage device.

Any of the disclosed embodiments of the execution unit 602 may be realized by one or more integrated circuits or one or more circuit boards. Specifically, any embodiment may be implemented by using a hardware description language (such as Verilog or VHDL) for circuit design, including circuit integration and layout. A circuit may be designed by utilizing the hardware description language in numerous manners. For example, the manufacturer of integrated circuits may realize implementations with application-specific integrated circuits (ASIC) or customer-design integrated circuits.

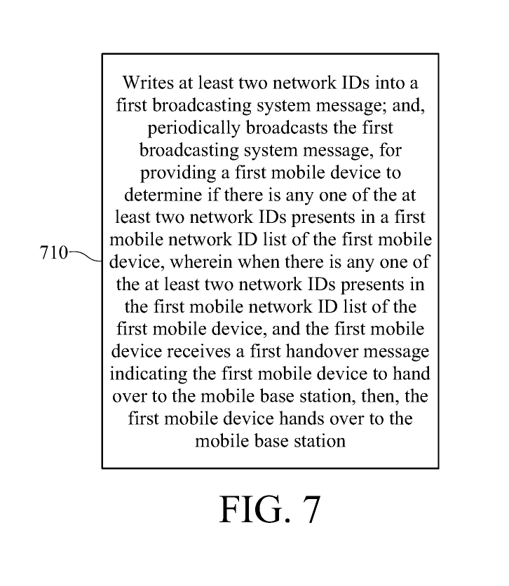

FIG. 7 shows a management method of a mobile base station according to an exemplary embodiment, which is adapted to the mobile base station 200. Step 710 comprises: the mobile base station 200 writes at least two network IDs into a first broadcasting system message; and, the mobile base station 200 periodically broadcasts the first broadcasting system message, for providing a first mobile device 100 to determine if there is any one of the at least two network IDs presents in a first mobile network ID list of the first mobile device 100, wherein when there is any one of the at least two network IDs presents in the first mobile network ID list of the first mobile device 100 and the first mobile device 100 receives a first handover message indicating the first mobile device 100 to hand over to the mobile base station 200, then, the first mobile device 100 hands over to the mobile base station 200.

In embodiments, after receiving the first broadcasting system message which is broadcast by the mobile base station 200, the mobile device 100 determines if there is any one of the at least two network IDs of the first broadcasting system message presents in a first mobile network ID list of the first mobile device 100. If there is, it indicates the mobile base station 200 could provide network services to the mobile device 100.

Continuing the previous paragraph, when the signal strength of mobile base station 200 is stronger than the signal strength of other base stations, in general, the mobile device 100 will receive a request to hand over to the mobile base station 200. Then, the mobile device 100 hands over to the mobile base station 200.

In embodiments, the aforementioned network ID is a Public Land Mobile Network Id (PLMNID).

In embodiments, the mobile base station 200 periodically broadcasts the first broadcasting system message, for providing a second mobile device 100′ to determine if there is any one of the at least two network IDs presents in a second mobile network ID list of the second mobile device 100′. Wherein when there is any one of the at least two network IDs presents in the second mobile network ID list of the second mobile device 100′, and the second mobile device 100′ receives a second handover message indicating the second mobile device 100′ to hand over to the mobile base station 200, then, the second mobile device 100′ hands over to the mobile base station 200. In embodiments, the second mobile device 100′ and the first mobile device 100 belong to different networks. After receiving the first broadcasting system message which is broadcast by the mobile base station 200, the mobile device 100 and 100′ determine individually if there is any one of the at least two network IDs of the first broadcasting system message presents in the mobile network ID list of the mobile device 100 and 100′. If there is, it indicates the mobile base station 200 could provide network services to the mobile device 100 or 100′. For example, if the mobile base station 200 provides 6 network services, then, the mobile devices belong to these 6 networks on the carriage could hand over to the mobile base station 200 individually, and further have the network services through the mobile base station 200.

FIG. 7 mainly shows the mobile base station 200 periodically broadcasts at least two broadcasting system messages including at least two network IDs, so that the mobile devices hand over to the mobile base station 200. The handover scheme, and the mobile base station 200 on how to communicate with the fixed base stations or the back-end system for providing network services, should refer to the definition of individual system, and does not require additional explanation here.

The mobile relay (MR) on the high-speed train is used as an example of the mobile base station 200. The Mobile Relay (MR) periodically broadcasts at least one broadcasting system message which includes the network IDs of serving networks. After the mobile devices (for example, 100, 100′, etc) on the high-speed train receive the at least one broadcasting system message, and when handover conditions are met, the mobile devices hand over to the mobile relay (MR) individually. The mobile relay (MR) play the role of the base station for the mobile devices.

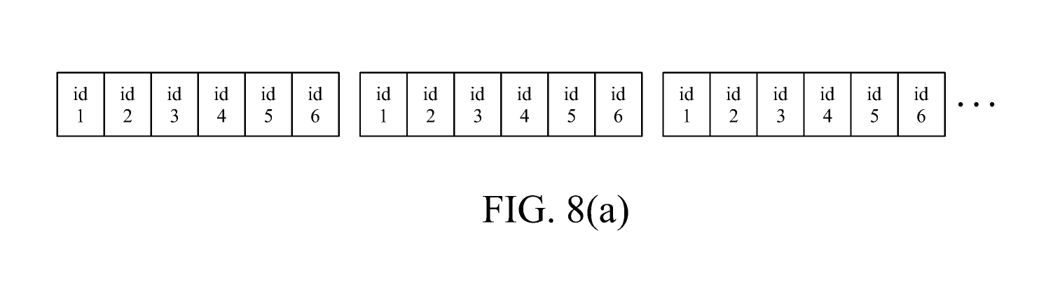

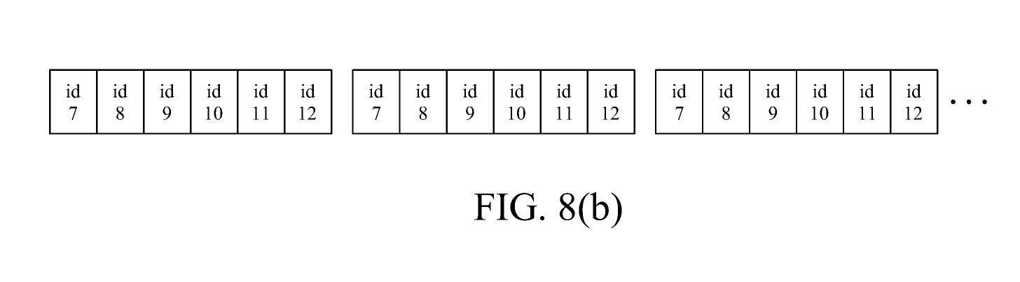

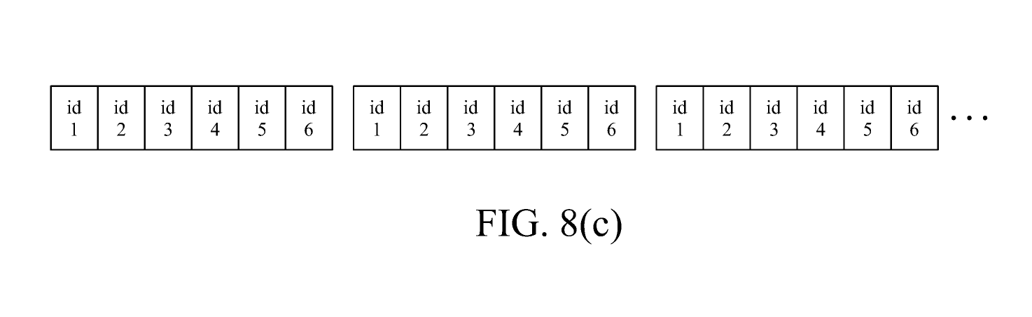

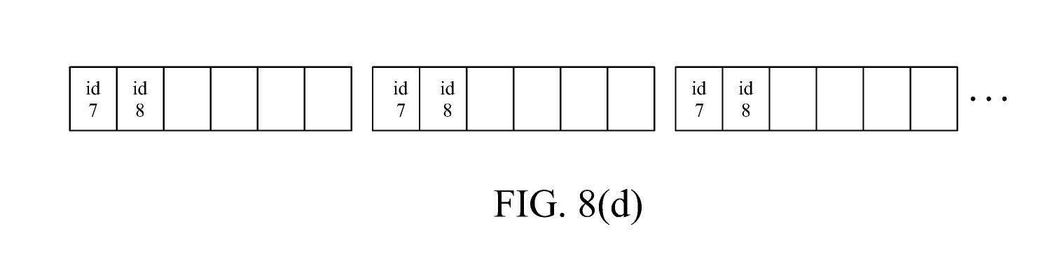

For example, if the mobile base station 200 provides 6 network services, and the pre-determined number of the broadcasting system message is 6. As shown in FIG. 8(a), the mobile base station 200 writes the network IDs (id1, id2, id3, id4, id5, id6) of the networks into a first broadcasting system message, and periodically broadcasts the first broadcasting system message.

In one embodiment, the mobile base station 200 determines if a number of the at least two network IDs exceeds a pre-determined number of the first broadcasting system message; and, when the number of the at least two network IDs exceeds the pre-determined number of the first broadcasting system message, then, writing part of the at least two network IDs into a second broadcasting system message, and, periodically broadcasts the first broadcasting system message and the second broadcasting system message.

For example, if the mobile base station 200 serves 12 networks, and the pre-determined number of the broadcasting system message is 6. As shown in FIG. 8(a) and FIG. 8(b), the mobile base station 200 writes the network IDs (id1, id2, id3, id4, id5, id6, id7, id8, id9, id10, id11, id12) of the networks into a first broadcasting system message and a second broadcasting system message, and periodically broadcasts the first broadcasting system message or the second broadcasting system message at a proper time. For example, the mobile base station 200 broadcasts 6 network IDs (for example, id1, id2, id3, id4, id5, id6) at the first run, and broadcasts other 6 network IDs (for example, id7, id8, id9, id10, id11, id12) at the second run.

In addition, for example, if the mobile base station 200 serves 8 networks, and the pre-determined number of the broadcasting system message is 6. The mobile base station 200 writes the network IDs (id1, id2, id3, id4 id5, id6, id7, id8) of the networks into a first broadcasting system message and a second broadcasting system message, and periodically broadcasts the first broadcasting system message or the second broadcasting system message at a proper time. For example, mobile base station 200 broadcasts 6 network IDs (for example, id1, id2, id3, id4, id5, id6) at the first run, and broadcasts other 2 network IDs (for example, id7, id8) at the second run, as shown in FIG. 8(c) and FIG. 8(d).

The mobile base station 200 may write the network IDs into the broadcasting system message in various ways, FIG. 8(a)˜FIG. 8(d) are considered as exemplars only, but not limited thereto.

In embodiments, the mobile network ID list includes Equivalent Home PLMN list (EHPLMN list), Equivalent PLMN list (EPLMN list), Home PLMN list (HPLMN list), and Registered PLMN list, etc.

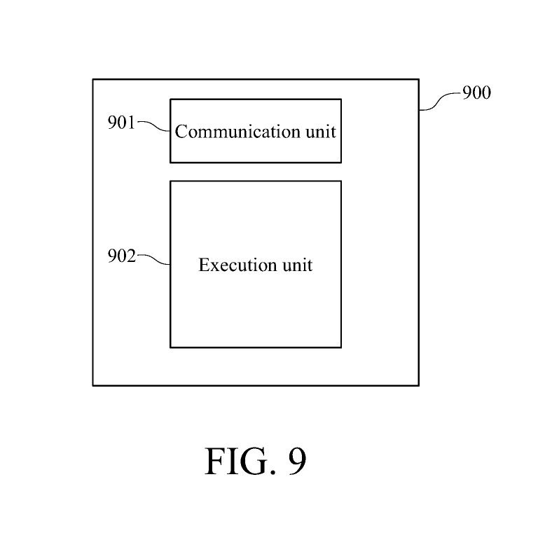

FIG. 9 shows a block diagram of a mobile base station 900, according to an exemplary embodiment. The mobile base station 900 comprises communication unit 901 and execution unit 902. The communication unit 901 is configured to transmit and receive messages. The execution unit 902 is configured to perform the management method of a mobile base station described above (shown in FIG. 7).

In embodiments, the communication unit 901 (shown in FIG. 9) is configured at least to receive or transmit messages with the fixed base station 300 and mobile devices 100, 100′.

In embodiments, the execution unit 902 may be realized by a processing unit for reading a plurality of computer-executable instructions from at least one storage device.

In embodiments, the execution unit 902 may be realized by one or more integrated circuits or one or more circuit boards. Specifically, any embodiment may be implemented by using a hardware description language (such as Verilog or VHDL) for circuit design, including circuit integration and layout. A circuit may be designed by utilizing the hardware description language in numerous manners. For example, the manufacturer of integrated circuits may realize implementations with application-specific integrated circuits (ASIC) or customer-design integrated circuits.

The aforementioned MBS tracking area update procedure and MD tracking area update procedure follow the procedure as defined in the practical application of the system, such as the Tracking Area Update Procedure of the Long Term Evolution-Advanced (LTE-A) system. The aforementioned handover procedure follows the procedure as defined in the practical application of the system. It should refer to the definition of individual system, and does not require additional explanation here.

The embodiments of present application provides network operators to share the mobile base station, and unnecessary to set mobile base station individually in the limited space of carriages. Then, it is possible to reduce implementation cost.

Further, the steps of the disclosed methods may be modified in various ways, including by reordering steps and/or inserting or deleting steps, without departing from the principles of the present disclosure.

Implementations of the various processes and features described herein may be embodied in a variety of different equipment or applications, particularly, for example, equipment or applications associated with handover and mobility management.

It will be apparent to those skilled in the art that various modifications and variations can be made to the disclosed embodiments. It is intended that the specification and examples be considered as exemplary only, with a true scope and spirit of the disclosure being indicated by the following claims.

What is claimed is:

1. A method of handover, adapted to a moving network system, comprising:
performing a mobile base station (MBS) tracking area update procedure corresponding to a mobile base station;
performing a mobile device (MD) tracking area update procedure corresponding to a mobile device;
transmitting, by a fixed base station, a mobile base station identity (ID) of the mobile base station to a mobile device (MD) mobility management entity corresponding to the mobile device;
transmitting, by the MD mobility management entity, a request for setting the mobile base station ID to the mobile device;
writing, by the mobile device, the mobile base station ID into a mobile network ID list of the mobile device; and
when the mobile device receives from the fixed base station a handover message indicating the mobile device to hand over to the mobile base station and; the mobile device determines the mobile network ID list includes the mobile base station ID of the mobile base station, then, the mobile device hands over to the mobile base station.

2. The method according to claim 1, wherein the mobile device, the fixed base station and the MD mobility management entity which correspond to the mobile device, participate the MD tracking area update procedure.

3. The method according to claim 2, wherein the MD tracking area update procedure is initialed by the mobile device or the MD mobility management entity.

4. The method according to claim 1, wherein the mobile base station, the fixed base station and a MBS mobility management entity which correspond to the mobile base station, participate the MBS tracking area update procedure.

5. The method according to claim 4, wherein the MBS tracking area update procedure is initialed by the mobile base station or the MBS mobility management entity.

6. The method according to claim 1, wherein transmitting the request for setting the mobile base station ID to the mobile device comprises:
setting the mobile base station ID to be a high priority.

7. The method according to claim 1, wherein the mobile network ID list comprises the mobile base station ID and at least one other mobile base station ID.

8. The method according to claim 1, wherein:
the fixed base station comprises at least one combination of a donor eNB, a small cell base station, a macro eNB, and a relay node.

9. The method according to claim 1, further comprising:
the mobile device periodically return the signal strength of at least one nearby base station to the fixed base station,
wherein the fixed base station determines the mobile device hands over to the mobile base station according to the signal strength of the at least one nearby base station.

10. A method of managing a mobile device, adapted to a mobile device (MD) mobility management entity, the method comprising:
performing a mobile device (MD) tracking area update procedure corresponding to a mobile device;
receiving a mobile base station identity (ID) of a mobile base station from a fixed base station; and,
transmitting a request for setting the mobile base station ID to the mobile device, so that the mobile device writes the mobile station ID into a mobile network ID list of the mobile device.

11. The method according to claim 10, wherein the MD tracking area update procedure is initialed by the mobile device or the MD mobility management entity.

12. The method according to claim 10, wherein transmitting the request for setting the mobile base station ID to the mobile device further comprises:
setting the mobile base station ID to be a high priority.

13. A mobile device (MD) mobility management entity, comprising:
a communication unit, the communication unit is configured to transmit and receive messages; and
an execution unit, the execution unit is configured to perform:
a mobile device (MD) tracking area update procedure corresponding to a mobile device;
receiving a mobile base station identity (ID) of a mobile base station from a fixed base station; and,
transmitting a request for setting the mobile base station ID to the mobile device, so that the mobile device writes the mobile station ID into a mobile network ID list of the mobile device.

14. The mobile device (MD) mobility management entity according to claim 13, wherein,
the MD tracking area update procedure is initialed by the mobile device or the MD mobility management entity.

15. The mobile device (MD) mobility management entity according to claim 13, wherein transmitting the request for setting the mobile base station ID to the mobile device further comprises:
setting the mobile base station ID to be a high priority.

16. The mobile device (MD) mobility management entity according to claim 13, wherein the execution unit is realized by a processing unit for reading a plurality of computer-executable instructions from at least one storage device or realized by one or more integrated circuits or one or more circuit boards.

17. A management method of a mobile base station, adapted to the mobile base station, the method comprising:
writing at least two network identities (IDs) into a first broadcasting system message; and,
periodically broadcasting the first broadcasting system message, for providing a first mobile device to determine if there is any one of the at least two network IDs presents in a first mobile network ID list of the first mobile device, wherein when there is any one of the at least two network IDs presents in the first mobile network ID list of the first mobile device, and the first mobile device receives a first handover message indicating the first mobile device to hand over to the mobile base station, then, the first mobile device hands over to the mobile base station.

18. The method according to claim 17, further comprising:
providing a second mobile device to determine if there is any one of the at least two network IDs presents in a second mobile network ID list of the second mobile device, wherein when there is any one of the at least two network IDs presents in the second mobile network ID list of the second mobile device, and the second mobile device receives a second handover message indicating the second mobile device to hand over to the mobile base station, then, the second mobile device hands over to the mobile base station, and
the second mobile device and the first mobile device belong to different networks.

19. The method according to claim 17, further comprising,
determine whether if a number of the at least two network IDs exceeds a pre-determined number of the first broadcasting system message; and
when the number of the at least two network IDs exceeds the pre-determined number of the first broadcasting system message, then,
writing part of the at least two network IDs into a second broadcasting system message, and
periodically broadcasting the first broadcasting system message and the second broadcasting system message.

20. A mobile base station, the mobile base station comprising:
a communication unit, the communication unit is configured to transmit and receive messages; and
an execution unit, the execution unit is configured to:
writing at least two network identities (IDs) into a first broadcasting system message; and,
periodically broadcasting the first broadcasting system message, for providing a first mobile device to determine if there is any one of the at least two network IDs presents in a first mobile network ID list of the first mobile device, wherein when there is any one of the at least two network IDs presents in the first mobile network ID list of the first mobile device, and the first mobile device receives a first handover message indicating the first mobile device to hand over to the mobile base station, then, the first mobile device hands over to the mobile base station.

21. The mobile base station according to claim 20, the execution unit is further configured to:
providing a second mobile device to determine if there is any one of the at least two network IDs presents in a second mobile network ID list of the second mobile device, wherein when there is any one of the at least two network IDs presents in the second mobile network ID list of the second mobile device, and the second mobile device receives a second handover message indicating the second mobile device to hand over to the mobile base station, then, the second mobile device hands over to the mobile base station, and
the second mobile device and the first mobile device belong to different networks.

22. The mobile base station according to claim 20, wherein the execution unit is further configured to:
determine whether if a number of the at least two network IDs exceeds a pre-determined number of the first broadcasting system message; and,
when the number of the at least two network IDs exceeds the pre-determined number of the first broadcasting system message, then,
writing part of the at least two network IDs into a second broadcasting system message, and
periodically broadcasting the first broadcasting system message and the second broadcasting system message.

23. The mobile base station according to claim 20, wherein the execution unit is realized by a processing unit for reading a plurality of computer-executable instructions from at least one storage device or realized by one or more integrated circuits or one or more circuit boards.
